(19) United States
(12) Patent Application Publication
(10) Pub. No.: US 2021/0271768 A1
(43) Pub. Date: Sep. 2, 2021

(54) IMAGE FORMING APPARATUS AND IMAGE FORMING METHOD

(71) Applicant: SHARP KABUSHIKI KAISHA, Sakai City (JP)

(72) Inventor: KENICHIROH IMAYOSHI, Sakai City (JP)

(21) Appl. No.: 17/183,785

(22) Filed: Feb. 24, 2021

(30) Foreign Application Priority Data
Mar. 2, 2020 (JP) 2020-034953

(51) Int. Cl. G06F 21/60; G06F 21/31; G06F 3/12

(52) U.S. Cl. CPC G06F 21/608; G06F 21/31; G06F 3/1274; G06F 3/1238; G06F 3/1222

(57) ABSTRACT

An image forming apparatus includes: a job receiver that receives a job involving an authentication process for performing printing after a user is authenticated; an operating device that receives input related to the authentication process; a motion sensor that detects people within a predetermined range; an image formation controller that starts the printing related to the job based on authentication information received by the operating device, with a person being detected by the motion sensor; and a job controller that interrupts the job related to the printing in process when the motion sensor no longer detects a person while the started printing is in process, wherein the job controller receives a selection as to whether to delete print data related to the interrupted job or to withhold the print data and use the print data when the job is resumed, and performs a process based on the selection.

### CROSS-REFERENCE TO RELATED APPLICATION

The present application claims priority from Japanese Application JP2020-034953, the content of which is hereby incorporated by reference into this application.

### BACKGROUND OF THE INVENTION

### Field of the Invention

The present invention relates to an image forming apparatus and an image forming method, and more particularly to processes to be performed when an authenticated user leaves the image forming apparatus while a job involving an authentication process for printing is in process.

### Description of the Background Art

An image forming apparatus is known that is connected to one or more information processing devices such as personal computers via a network to receive data from the information processing devices and print the data.

In a situation in which the image forming apparatus is at a distance from an information processing device and a confidential document is printed, someone other than the user who has printed the confidential document can mistakenly take away the print-out outputted from the image forming apparatus during or after the printing of data transmitted from the information processing device.

In order to solve the above-described problem, there is a known printing-related function referred to as a security printing function (hereinafter, also referred to as print job holding in this specification). According to the security printing function, the printing of the data transmitted from the information processing device and received by the image forming apparatus is not started and kept on hold until the user comes to the image forming apparatus and inputs a password. This prevents a third party from taking away the print-out before the user arrives and receives the print-out. However, it is possible that the user leaves the image forming apparatus between the start and the end of the printing.

Regarding this problem, Japanese Unexamined Patent Application Publication No. 2015-71283 discloses an image forming apparatus that displays a warning screen on a display and interrupts the printing when a people detector detects the absence of people between the start and the end of the printing according to the security printing function. The interrupted printing is resumed once the detector detects the presence of a person and a password for the relevant print data is inputted.

### SUMMARY OF THE INVENTION

However, Japanese Unexamined Patent Application Publication No. 2015-71283 does not disclose details of handling of the data related to the interrupted printing and procedures for the resumption of the printing.

In the first place, the user who has started printing related to a held print job comes to the image forming apparatus in order to pick up the print-out that is important to the user. That is, basically, the user is likely to stay by the image forming apparatus until the printing is complete.

However, in the case of printing of data that is processing-intensive for the image forming apparatus and printing of a large number of pages or copies, for example, the printing can take longer than the user expects. As a result, the user can mistakenly assume that the printing has been finished while it is actually still in process, or can mistakenly think that the printing is being stalled due to some fault and leave the image forming apparatus to check.

Furthermore, the user can be in a busy workplace and therefore prevented from staying by the image forming apparatus.

Depending on print data which the user is dealing with and conditions under which the image forming apparatus is used, reasons for interruption of printing vary, and the frequency of interruption of a held print job and optimal measures therefor also vary. Whether or not to withhold print data related to an interrupted held print job for resumption of the printing also varies from user to user.

In view of the above-described circumstances, an embodiment of the present invention has been made to allow a user to select a suitable mode for handling print data related to an interrupted held print job and resuming printing.

An embodiment of the present invention provides an image forming apparatus including: a job receiver that receives a job involving an authentication process for performing printing after a user is authenticated; an operating device that receives input related to the authentication process; a motion sensor that detects people within a predetermined range, the people including a user who provides input to the operating device; an image formation controller that starts the printing related to the job based on authentication information received by the operating device, with a person being detected by the motion sensor; and a job controller that interrupts the job related to the printing in process when the motion sensor no longer detects a person while the started printing is in process, wherein the job controller receives a selection as to whether to delete print data related to the interrupted job or to withhold the print data and use the print data when the job is resumed, and performs a process based on the selection.

According to another aspect, an embodiment of the present invention provides an image forming method including implementation by a computer of: receiving a job involving an authentication process for performing printing after a user is authenticated; receiving, through an operating device, input related to the authentication process; detecting, through a motion sensor, a user who inputs authentication information to the operating device; starting the printing related to the job based on the authentication information received by the operating device, with a person being detected by the motion sensor; interrupting the job related to the printing in process when the motion sensor no longer detects a person while the started printing is in process; receiving, before or after the interruption of the job, a selection as to whether to delete print data related to the interrupted job or to withhold the print data and use the print data when the job is resumed; and performing a process on the interrupted job based on the selection.

In the image forming apparatus according to an embodiment of the present invention, the job controller receives a selection as to whether to delete print data related to the interrupted job or to withhold the print data and use the print data when the job is resumed, and performs a process based on the selection. This allows the user to select a suitable mode with respect to the process related to a held print job that has been interrupted.

The same applies to the image forming method according to an embodiment of the present invention.

### BRIEF DESCRIPTION OF THE DRAWINGS

FIG. 1 is a perspective view of an appearance of a multifunction peripheral, which is an image forming apparatus according to an embodiment of the present invention.

FIG. 2 is a plan view of the multifunction peripheral illustrated in FIG. 1.

FIG. 3 is a block diagram illustrating an electrical configuration of the multifunction peripheral illustrated in FIG. 1.

FIG. 4A is a first flowchart showing a flow of a process according to the embodiment to be performed from the start of a held print job to interruption thereof due to a user leaving the multifunction peripheral.

FIG. 4B is a second flowchart showing a flow of a process according to the embodiment to be performed from the start of a held print job to interruption thereof due to a user leaving the multifunction peripheral.

FIG. 4C is a third flowchart showing a flow of a process according to the embodiment to be performed from the start of a held print job to interruption thereof due to a user leaving the multifunction peripheral.

FIG. 5 is an explanatory diagram illustrating an example of a screen for configuring system settings related to interruption and resumption of a held print job according to the embodiment.

FIG. 6A is a first flowchart showing a process according to the embodiment to be performed when a user having a held job being withheld logs in again.

FIG. 6B is a second flowchart showing a process according to the embodiment to be performed when a user having a held job being withheld logs in again.

FIG. 7 is an explanatory diagram illustrating an example of an instruction input screen according to the embodiment that is displayed for a user when a held print job is resumed.

FIG. 8 is an explanatory diagram showing settings related to interruption of a held print job and processes based on the settings according to the embodiment.

FIG. 9 is an explanatory diagram showing settings related to resumption of a held print job and processes based on the settings according to the embodiment.

### DESCRIPTION OF THE PREFERRED EMBODIMENTS

The present invention will now be described in further detail with reference to the accompanying drawings. Note that the following explanations are mere examples in all respects, and should not be construed as limiting the present invention.

### Configuration Example of Image Forming Apparatus

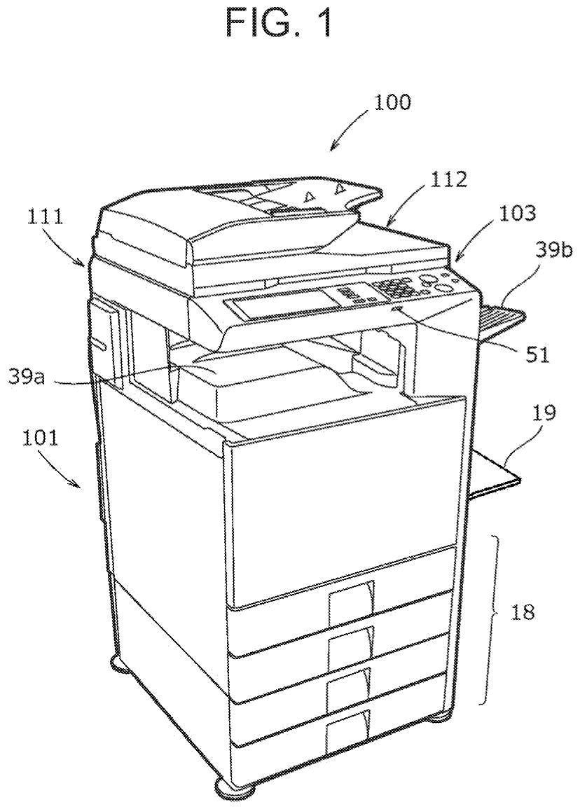

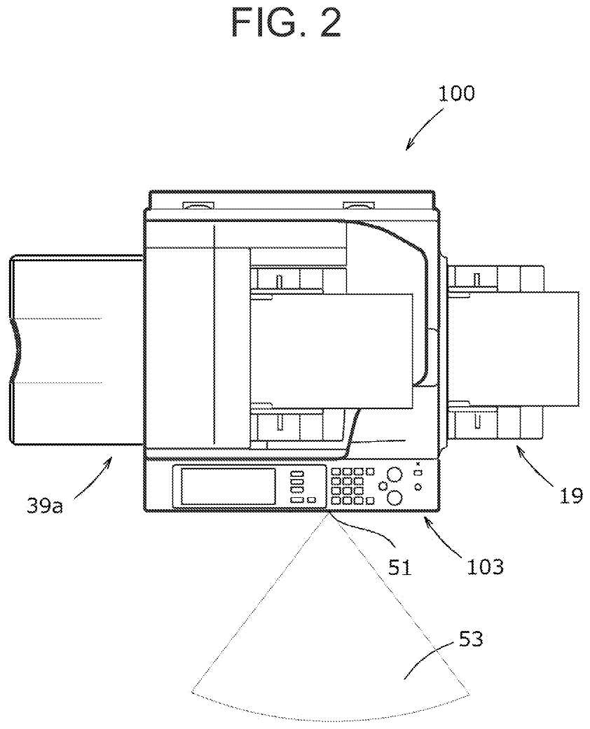

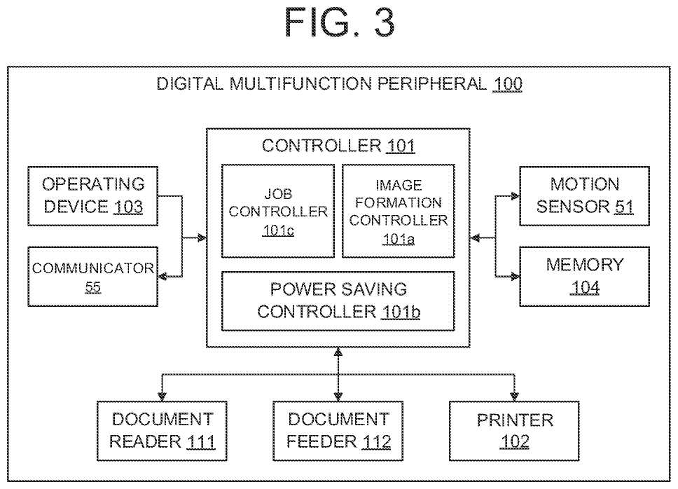

FIG. 1 is a perspective view of an appearance of a multifunction peripheral 100, which is an image forming apparatus according to an embodiment of the present invention. FIG. 2 is a plan view of the multifunction peripheral 100 illustrated in FIG. 1. FIG. 3 is a block diagram illustrating an electrical configuration of the multifunction peripheral 100 according to the present embodiment. As illustrated in FIGS. 1 and 2, the multifunction peripheral 100 includes a document reader 111, a printer 102, an operating device 103, a document feeder 112, feed trays 18, a manual feed tray 19, ejection trays 39a and 39b, and a motion sensor 51.

The multifunction peripheral 100 performs scan, print, and copy jobs based on instructions received from a user through the operating device 103 and a communicator 55.

The printer 102 prints a color image on a print sheet using black (K), cyan (C), magenta (M), and yellow (Y) colors. Alternatively, the printer 102 prints a monochrome image on a print sheet using a single color (for example, black).

The print sheet is fed from one of the four feed trays 18. Alternatively, the print sheet is fed from the manual feed tray 19. The print sheet on which the color image or the monochrome image has been printed by the printer 102 is ejected onto the ejection tray 39a or 39b. The printer 102 is controlled by an image formation controller 101a described below.

Subsequently, an electrical configuration of the multifunction peripheral 100 will be briefly described.

A controller 101 in FIG. 3 controls the multifunction peripheral 100 in an integrated manner. The controller 101 includes a central processing unit (CPU), random-access memory (RAM), read-only memory (ROM), various interface circuits, and the like. The controller 101 includes functions of the image formation controller 101a, a power saving controller 101b, and a job controller 101c.

The printer 102 prints an image on a print sheet.

The communicator 55 is a circuit and firmware of a communication interface that transmits and receives communication data to and from an external device and receives a print job execution request from an external computer, for example.

The operating device 103 includes a plurality of input keys and a liquid crystal display device. Memory 104 is a non-volatile storage medium such as a hard disk device (HDD) or flash memory, and stores various data and programs therein.

In the case of a scan job or a copy job, the controller 101 receives a job instruction from the user through the operating device 103. In the case of a print job, the controller 101 receives a job instruction from an external information processing device through the communicator 55. Upon receiving a copy job execution request through the operating device 103, for example, the controller 101 serving as the job controller 101c starts executing the copy job. The controller 101 serving as the image formation controller 101a controls the document reader 111 and the document feeder 112 to cause the document feeder 112 to feed an original document. The controller 101 then causes the document reader 111 to read an image of the original document and stores image data representing the image of the original document in the memory 104. The controller 101 further controls the printer 102 to cause the printer 102 to print, on a print sheet, the image of the original document represented by the image data in the memory 104.

An outline of the configuration of the multifunction peripheral 100 has been described above.

The motion sensor 51 detects the presence of the user in front of the operating device 103 who has come to operate the operating device 103, so that a power saving mode is deactivated before the user operates the operating device 103.

FIG. 2 illustrates a fan-shaped operation area 53, which is an area where the motion sensor 51 detects human bodies. Once the user enters the operation area 53, the motion sensor 51 detects the user.

A pyroelectric sensor, which senses changes in surrounding temperature and detects human bodies by sensing a certain level of temperature change, may be used as the motion sensor 51.

The controller 101 serving as the power saving controller 101b causes the multifunction peripheral 100 to transition from a normal mode to the power saving mode if no job execution request or no user instruction is received for a period of time longer than a predetermined period of time. During the normal mode, execution of a job can be started as soon as an instruction is received.

During the power saving mode, power to each unit of the multifunction peripheral 100 is cut off or reduced, and thus power consumption is significantly reduced compared to the normal mode. However, it takes some time to return to the state in which execution of a job can be started as soon as an instruction is received.

Upon the motion sensor 51 detecting a user approaching the multifunction peripheral 100, the power saving controller 101b causes the multifunction peripheral 100 to return from the power saving mode to the normal mode.

Processes to Be Performed from Start to Interruption of Held Print Job

Referring to flowcharts, the following describes flows of processes to be performed from the start of a held print job to interruption of printing thereof due to the user leaving the multifunction peripheral 100.

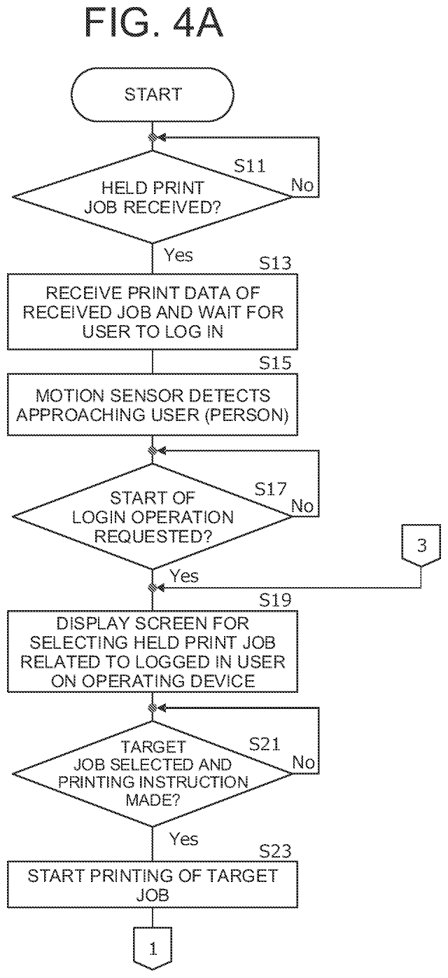

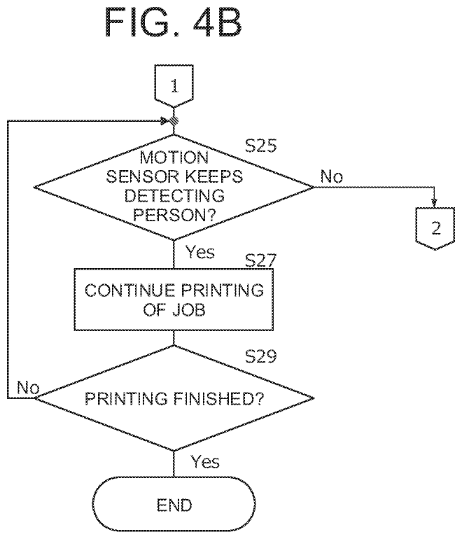

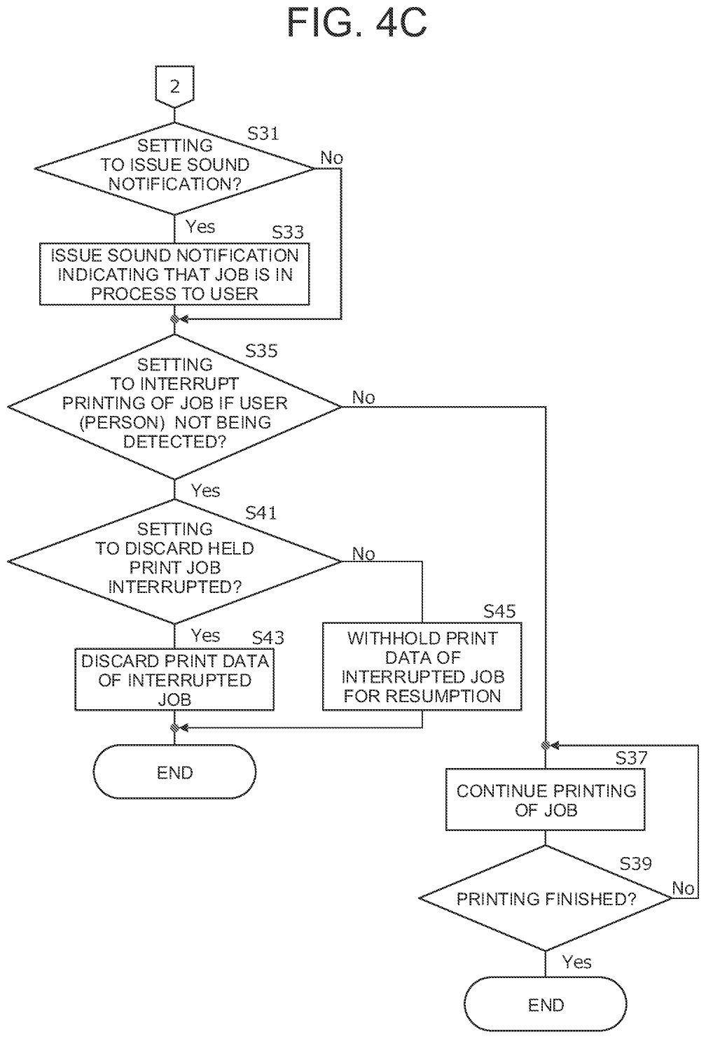

FIGS. 4A to 4C are flowcharts showing the flows of the processes according to the present embodiment to be performed from the start of a held print job to interruption of printing thereof due to the user leaving the multifunction peripheral 100.

As shown in FIG. 4A, upon receiving an execution request for a held print job, the controller 101 serving as the job controller 101c receives and stores, in the memory 104, print data related to the held print job received, and waits for a login operation by the user (step S13).

When the user who has requested the execution of the held print job approaches the operating device 103 of the multifunction peripheral 100 to perform the login operation, the motion sensor 51 detects the user (step S15).

Once the user arrives at the operating device 103 and performs the login operation (Yes in step S17), the controller 101 serving as the job controller 101c processes the login. According to the present embodiment, the user is to enter a user name and a password as authentication information for the login.

The controller 101 causes the operating device 103 to display a login screen in response to a predetermined operation performed by the user, and checks the user name and the password entered on the login screen against pre-registered authentication information to authenticate the user. The controller 101 then causes the operating device 103 to display a screen for the user to specify a held print job to be printed as long as the authenticated user has a held print job (step S19). The controller 101 then waits for input from the user (step S21).

Upon a held print job to be printed being specified (Yes in step S21), the job controller 101c causes the image formation controller 101a to start printing of the specified job (step S23). That is, the image formation controller 101a does not start the printing of the job until the user has been authenticated, waiting for the user to be authenticated before starting the printing of the job. Since the image formation controller 101a starts the printing in response to the operation on the screen for specifying the held print job, the motion sensor 51 detects the user who comes to operate the screen on the operating device 103 by the time the printing is started.

After the printing has been started, the controller 101 serving as the job controller 101c monitors whether or not the motion sensor 51 keeps detecting a person (user) (step S25 in FIG. 4B). If the motion sensor 51 is detecting a person (Yes in step S25), the job controller 101c determines that there is a user nearby, and the image formation controller 101a continues the printing (step S27). Once the printing has been finished (Yes in step S29), the controller 101 serving as the image formation controller 101a and the job controller 101c ends the process related to the held print job.

Until the printing of the held print job is finished (No in step S29), the job controller 101c continues to monitor whether or not the motion sensor 51 is detecting a person (a loop of steps S25, S27, and S29).

When the motion sensor 51 no longer detects a person while the printing is in process (No in step S25), the job controller 101c checks whether or not settings are to issue a sound notification to the user (step S31 in FIG. 4C).

If the settings are to issue a notification (Yes in step S31), a sound notification indicating that the printing of the job is in process is issued to the user (step S33). For example, a voice message “Printing is in process” is outputted. The user who is leaving the multifunction peripheral 100 without knowing that the printing of the held print job has not been finished yet is expected to stay as a result of hearing the voice message.

If the settings are not to issue a sound notification (No in step S31), no notification is outputted. For example, in a situation in which there are many people who find sound notifications annoying or the user is very busy and often has to give priority to another task, the settings may be configured not to issue a voice notification.

When the motion sensor 51 no longer detects a person while the printing of the held print job is in process, the job controller 101c subsequently checks whether or not the settings are to interrupt the printing (step S35).

If the settings are not to interrupt the printing (No in step S35), the printing in process is continued until the completion thereof (step S37), and the process ends once the printing is complete (Yes in step S39).

If the job controller 101c determines in step S35 that the settings are to interrupt the printing when the motion sensor 51 no longer detects a person while the printing of the held print job is in process (Yes in step S35), the following process is further performed. That is, the job controller 101c checks whether or not the settings are to discard the print data related to the held print job interrupted (step S41).

If the settings are to discard the print data related to the interrupted held print job (Yes in step S41), the print data is discarded (step S43) and the process ends. If the settings are to withhold the print data related to the interrupted held print job (No in step S41), the print data in the memory 104 is withheld without being deleted for resumption of the held print job (step S45), and the process ends.

The processes to be performed from the start to interruption of printing of a held print job have been described above.

Note here that the determinations in steps S35 and S41 are to check settings preconfigured by the user. The settings according to the present embodiment are included as items of system settings of the multifunction peripheral 100.

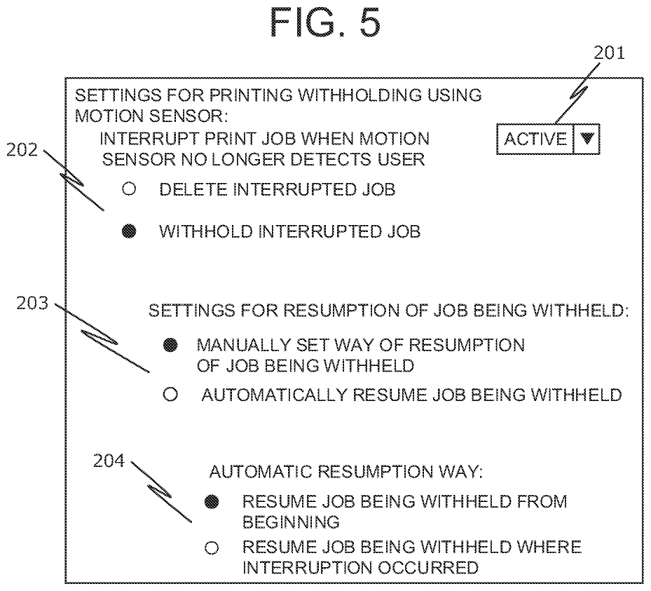

FIG. 5 is an explanatory diagram illustrating an example of a screen for configuring system settings related to the interruption and the resumption of a held print job according to the present embodiment.

As illustrated in FIG. 5, the system settings related to the interruption and the resumption of a held print job include a system setting 201 as to whether or not to interrupt printing in process when the motion sensor 51 no longer detects a person while the printing is in process. The determination in step S35 is made based on this setting item. The system settings further include a system setting 202 as to whether to delete or withhold, when printing of a job is interrupted, print data related to the job interrupted. The determination in step S41 is made based on this setting item.

As illustrated in FIG. 5, the items of the system settings include the following system setting for a case where there is a held print job for which printing has been interrupted and withheld, and the user related to this job logs in again. This is a system setting 203 as to whether to resume the withheld printing using the login as a trigger or to resume the printing after receiving an instruction from the user.

The system settings further include, for resuming the printing using the login as a trigger, a system setting 204 as to whether to resume the printing from the beginning of the job or to resume the printing where the interruption occurred by excluding a portion printed before the interruption.

Although not illustrated in FIG. 5, the system settings may further include an item that sets a job withholding period, which specifies, when a job is interrupted and withheld, how long the job is to be withheld.

### Processes to Be Performed When User Having Job Being Withheld Logs In Again

Subsequently, the following describes processes to be performed when a user having a held print job for which printing has been interrupted and print data is being withheld performs the login operation again through the operating device 103. That is, these processes are performed when a user who left the multifunction peripheral 100 during the printing of the held print job comes back to the multifunction peripheral 100 and logs in again.

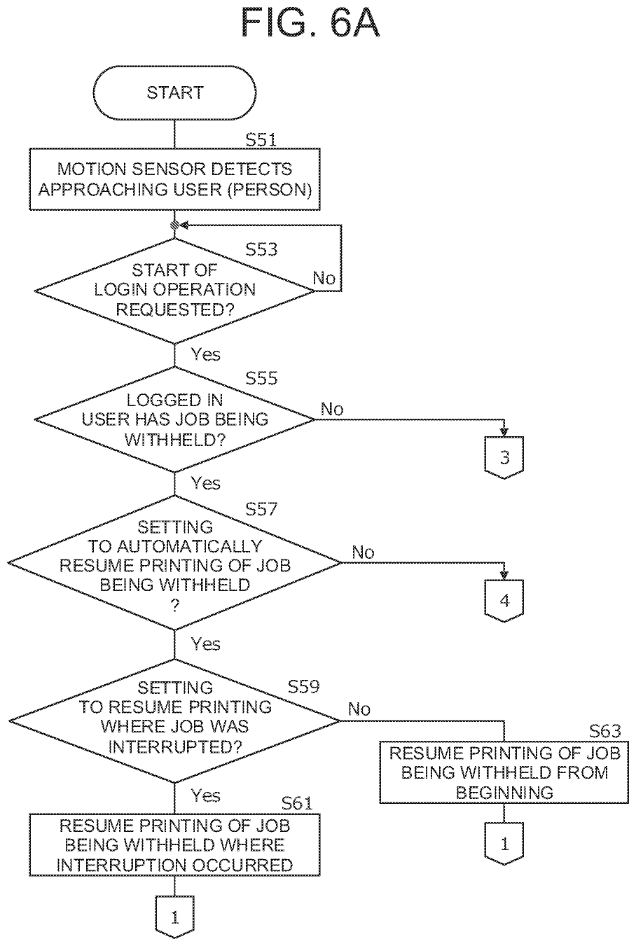

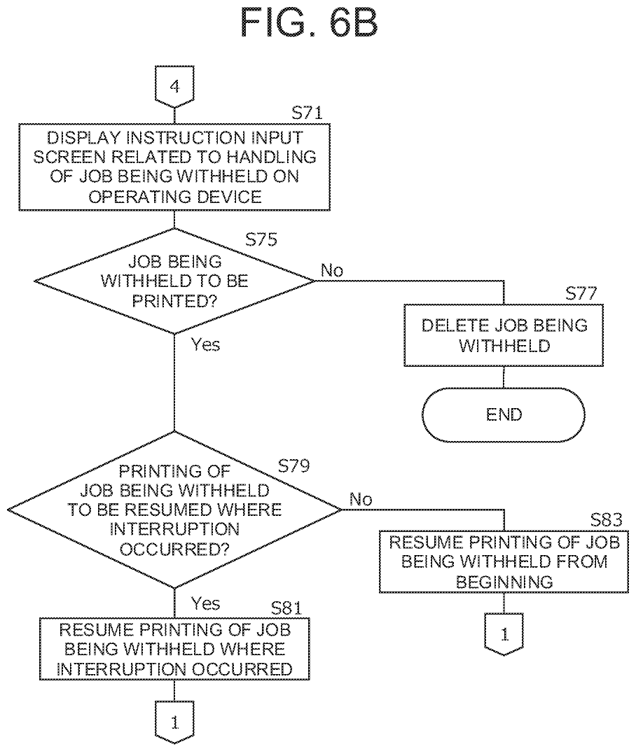

FIGS. 6A and 6B are flowcharts showing the processes to be performed according to the present embodiment when a user having a held job being withheld logs in again.

When a user who has requested execution of a held print job approaches the operating device 103 of the multifunction peripheral 100 to perform the login operation, the motion sensor 51 detects the user (step S51).

Once the user arrives at the operating device 103 and performs the login operation by entering a user name and a password (Yes in step S53), the controller 101 serving as the job controller 101c processes the login.

The controller 101 causes the operating device 103 to display the login screen in response to a predetermined operation performed by the user, and checks the user name and the password entered on the login screen against pre-registered authentication information to authenticate the user.

The controller 101 then determines whether or not the authenticated user has a held print job for which printing has been interrupted and print data is being withheld (step S55).

If the user has no held print job being withheld (No in step S55), the process returns to step S19 shown in FIG. 4A, and as already mentioned, processing of a held print job for which printing is to be newly started is performed.

If the user has a held print job being withheld (Yes in step S55), the job controller 101c refers to the system setting 203 as to whether to resume the printing being withheld using the login as a trigger or to resume the printing after receiving an instruction from the user (step S57).

If the system setting 203 is to resume the printing being withheld using the login as a trigger (Yes in step S57), the job controller 101c subsequently refers to the system setting 204 as to whether to resume the printing from the beginning of the job or to resume the printing where the interruption occurred by excluding a portion printed before the interruption (step S59).

If the system setting 204 is to resume the printing where the interruption occurred (Yes in step S59), the job controller 101c requests the image formation controller 101a to resume the printing of the held print job being withheld where the interruption occurred. In response, the image formation controller 101a resumes the printing related to the held print job being withheld where the interruption occurred (step S61).

After the printing has been resumed, the process returns to step S25 of the flow in FIG. 4B, and the job controller 101c continues to monitor whether or not the motion sensor 51 is detecting a user until the printing is finished.

If the job controller 101c determines in step S59 that the system setting 204 is to resume the printing from the beginning of the job (No in step S59), the job controller 101c requests the image formation controller 101a to resume the printing of the held print job being withheld from the beginning. In response, the image formation controller 101a resumes the printing related to the held print job being withheld from the beginning (step S63).

After the printing has been resumed, the process returns to step S25 of the flow in FIG. 4B, and the job controller 101c continues to monitor whether or not the motion sensor 51 is detecting a user until the printing is finished.

If the item of the system setting 203 referred to in the determination in step S57 is to resume the printing after receiving from the user an instruction about the held print job being withheld (No in step S57), the next process is performed. The job controller 101c displays, on the operating device 103, an instruction input screen related to handling of the held print job being withheld and waits for an instruction from the user (step S71).

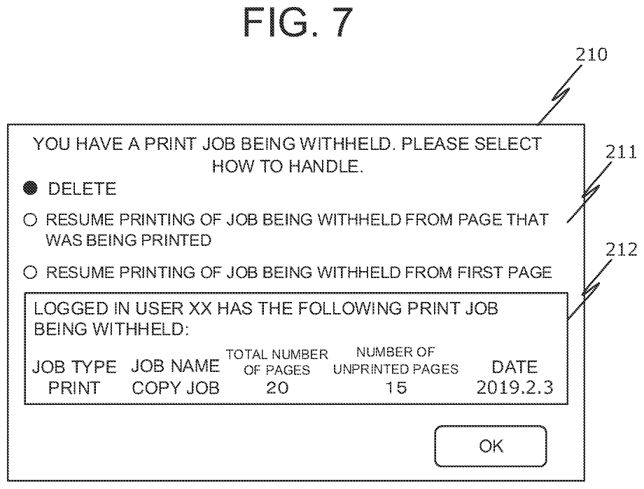

FIG. 7 is an explanatory diagram illustrating an example of the instruction input screen displayed on the operating device 103 by the job controller 101c at step S71.

As illustrated in FIG. 7, the instruction input screen 210 includes an instruction selection field 211 and a withheld job information field 212. The instruction selection field 211 is for the user to select and instruct how to handle the job being withheld.

FIG. 7 shows three options. A first option is to delete the job and print data thereof being withheld. A second option is to resume the printing from a page that was being printed. A third option is to resume the printing from the first page. In response to the user selecting one of the options and pressing an “OK” button, the job controller 101c receives the user's instruction.

The withheld job information field 212, which shows details of the job being withheld, is located below the instruction selection field 211. The user can confirm the details of the job being withheld by referring to the withheld job information field 212.

If the first option to delete the job and the print data thereof being withheld is selected on the instruction input screen 210 (No in step S75), the job controller 101c deletes the job and the print data thereof being withheld, and the process ends (step S77).

If the second option to resume the printing from a page that was being printed is selected on the instruction input screen 210 (Yes in step S79 after Yes in step S75), the job controller 101c requests the image formation controller 101a to resume the printing of the held print job being withheld where the interruption occurred. In response, the image formation controller 101a resumes the printing related to the held print job being withheld where the interruption occurred (step S81).

After the printing has been resumed, the process returns to step S25 of the flow in FIG. 4B, and the job controller 101c continues to monitor whether or not the motion sensor 51 is detecting a user until the printing is finished.

If the third option to resume the printing from the first page is selected on the instruction input screen 210 (No in step S79 after Yes in step S75), the job controller 101c requests the image formation controller 101a to resume the printing of the held print job being withheld from the beginning. In response, the image formation controller 101a resumes the printing related to the held print job being withheld from the beginning (step S83).

After the printing has been resumed, the process returns to step S25 of the flow in FIG. 4B, and the job controller 101c continues to monitor whether or not the motion sensor 51 is detecting a user until the printing is finished.

The processes have been described above that are performed when a user having a held print job for which printing has been interrupted and print data is being withheld performs the login operation again through the operating device 103.

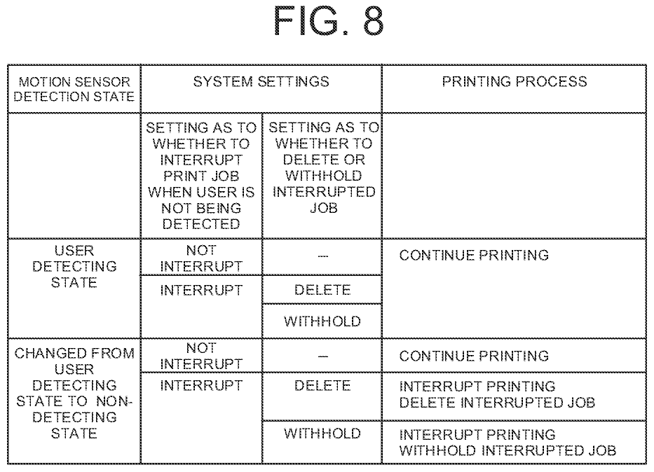

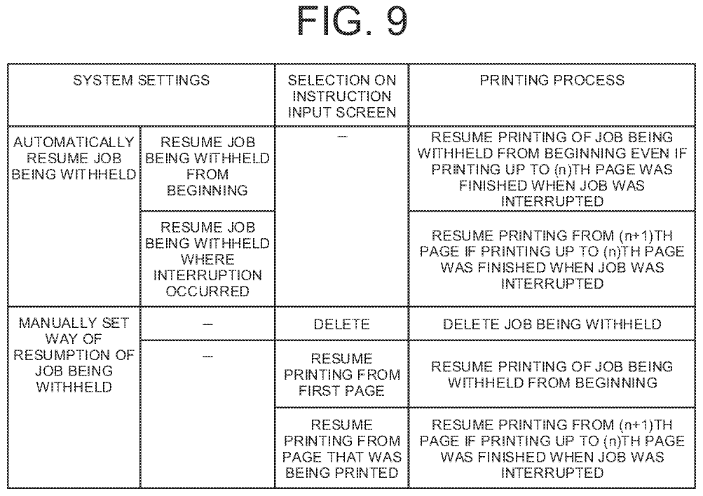

FIGS. 8 and 9 summarize the flows of the processes described above. FIG. 8 summarizes the settings related to the interruption of a held print job and the processes based on the settings, and corresponds to the processes shown in FIGS. 4A to 4C.

FIG. 9 summarizes the settings related to the resumption of a held print job and the processes based on the settings, and corresponds to the processes shown in FIGS. 6A and 6B.

As described above,

(i) an image forming apparatus according to an embodiment of the present invention includes: a job receiver that receives a job involving an authentication process for performing printing after a user is authenticated; an operating device that receives input related to the authentication process; a motion sensor that detects people within a predetermined range, the people including a user who provides input to the operating device; an image formation controller that starts the printing related to the job based on authentication information received by the operating device, with a person being detected by the motion sensor; and a job controller that interrupts the job related to the printing in process when the motion sensor no longer detects a person while the started printing is in process, wherein the job controller receives a selection as to whether to delete print data related to the interrupted job or to withhold the print data and use the print data when the job is resumed, and performs a process based on the selection.

In an embodiment of the present invention, the job involving an authentication process refers to a job that is executable only by an authenticated user. Specific embodiments thereof include, for example, a print job (held print job) for which printing of data transmitted from an information processing device and received by the image forming apparatus is not started and is put on hold until the user comes to the image forming apparatus and inputs a password. Alternatively, the job involving an authentication process refers to a copy job that is executable only by an authenticated user.

Furthermore, the job refers to a series of processes to be executed by the image forming apparatus in response to an instruction from a user. Specific embodiments thereof include, for example, a print job for printing data received from an external information processing device, and a copy job, or the like, for reading an image of an original document and printing the image.

Furthermore, the authentication process refers to a process for confirming a specific user using, for example, a user name, a password, and the like. The authentication is not limited to being performed using a combination of a user name and a password. For example, various ways are usable such as an IC card containing pre-stored identification information of a user, and biometric authentication through fingerprint, iris, or facial recognition.

The motion sensor is provided on the image forming apparatus and detects people within a predetermine range from the image forming apparatus. In order to avoid unnecessary power consumption, the image forming apparatus transitions to the power saving mode if no user who operates the image forming apparatus is by the image forming apparatus. Upon the motion sensor detecting a user approaching the image forming apparatus, the image forming apparatus is awakened from the power saving mode. The motion sensor is used to awaken the image forming apparatus early enough for the image forming apparatus to complete transition from the power saving mode by the time the user comes to the location of the operating device. The predetermined range is, for example, a fan-shaped range within a radius of a few meters from the motion sensor.

Furthermore, the operating device refers to a unit including an input device and a display device for a user to input an instruction to the image forming apparatus and recognize the state of the image forming apparatus and a response to the instruction. Specific embodiments thereof include, for example, a unit including a liquid crystal display, a touch panel, and an operation key.

Furthermore, the image formation controller refers to a unit that performs printing on a print sheet. Specific embodiments thereof include, for example, an electrophotographic or inkjet print engine.

The job receiver and the job controller include, for example, a CPU being a main component, memory, an input/output circuit, and the like, as hardware resources. Functions thereof are implemented by the CPU executing a control program prestored in the memory.

The following describes other embodiments of the present invention.

Embodiment 2: The job controller may receive in advance a selection as to whether to resume, when a user has a job being withheld and the operating device receives input of authentication information related to the job being withheld, the job being withheld after receiving an instruction from the user or to resume the job being withheld without waiting for the instruction from the user, and perform a process based on the selection.

This allows each of users having a job being withheld to configure in advance a setting as to whether to resume the job being withheld using, as a trigger, input of authentication information of the user or to resume the job being withheld after receiving an explicit instruction from the user.

Embodiment 3: The job controller may receive a selection as to whether to resume the printing related to the job being withheld from the beginning or to resume the printing where interruption occurred, and perform a process based on the selection.

This allows each of users having a job being withheld to configure in advance or select when printing of the job is resumed, a setting as to whether to resume the printing from the beginning or to resume the printing where interruption occurred using print data related to the job being withheld.

Embodiment 4: The job controller may receive a selection by a user as to whether to delete, when the user has an interrupted job and the operating device receives input of authentication information related to the interrupted job, print data related to the interrupted job or to resume the interrupted job and use the print data for printing of the interrupted job, and perform a process based on the selection.

This allows each of users having an interrupted job to configure in advance or select when printing of the job is resumed, a setting as to whether to delete the job or to resume the printing using print data being withheld upon the user inputting authentication information.

Embodiment 5: The job controller may further receive a selection as to whether to resume the printing related to the interrupted job from the beginning or to resume the printing where interruption occurred by excluding a portion printed before the interruption, and perform a process based on the selection.

This allows the user to configure in advance or select, when the printing of the interrupted job is resumed, a setting as to whether to resume the printing from the beginning or to resume the printing where the interruption occurred.

Embodiment 6: The job controller may receive in advance a selection as to whether or not to notify, when the motion sensor no longer detects a person while the started printing is in process, that the printing is in process, and perform a process based on the selection.

This allows each user to configure a setting to issue, as the user leaves the predetermined range or the vicinity of the operating device, a notification indicating that the printing is not finished yet and encouraging the user to stay when the motion sensor no longer detects a person while the printing is in process.

The present invention further includes, as another embodiment, an image forming method including implementation by a computer of: receiving a job involving an authentication process for performing printing after a user is authenticated; receiving, through an operating device, input related to the authentication process; detecting, through a motion sensor, a user who inputs authentication information to the operating device; starting the printing related to the job based on the authentication information received by the operating device, with a person being detected by the motion sensor; interrupting the job related to the printing in process when the motion sensor no longer detects a person while the started printing is in process; receiving, before or after the interruption of the job, a selection as to whether to delete print data related to the interrupted job or to withhold the print data and use the print data when the job is resumed; and performing a process on the interrupted job based on the selection.

Preferred embodiments of the present invention include those obtained by combining any of the embodiments described above.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus comprising:
a job receiver that receives a job involving an authentication process for performing printing after a user is authenticated;
an operating device that receives input related to the authentication process;
a motion sensor that detects people within a predetermined range, the people including a user who provides input to the operating device;
an image formation controller that starts the printing related to the job based on authentication information received by the operating device, with a person being detected by the motion sensor; and
a job controller that interrupts the job related to the printing in process when the motion sensor no longer detects a person while the started printing is in process, wherein
the job controller receives a selection as to whether to delete print data related to the interrupted job or to withhold the print data and use the print data when the job is resumed, and performs a process based on the selection.

2. The image forming apparatus according to claim 1, wherein the job controller receives in advance a selection as to whether to resume, when a user has a job being withheld and the operating device receives input of authentication information related to the job being withheld, the job being withheld after receiving an instruction from the user or to resume the job being withheld without waiting for the instruction from the user, and performs a process based on the selection.

3. The image forming apparatus according to claim 2, wherein the job controller receives a selection as to whether to resume the printing related to the job being withheld from the beginning or to resume the printing where interruption occurred, and performs a process based on the selection.

4. The image forming apparatus according to claim 1, wherein the job controller receives a selection by a user as to whether to delete, when the user has an interrupted job and the operating device receives input of authentication information related to the interrupted job, print data related to the interrupted job or to resume the interrupted job and use the print data for printing of the interrupted job, and performs a process based on the selection.

5. The image forming apparatus according to claim 4, wherein the job controller further receives a selection as to whether to resume the printing related to the interrupted job from the beginning or to resume the printing where interruption occurred by excluding a portion printed before the interruption, and performs a process based on the selection.

6. The image forming apparatus according to claim 1, wherein the job controller receives in advance a selection as to whether or not to notify, when the motion sensor no longer detects a person while the started printing is in process, that the printing is in process, and performs a process based on the selection.

7. An image forming method comprising implementation by a computer of:
receiving a job involving an authentication process for performing printing after a user is authenticated;
receiving, through an operating device, input related to the authentication process;
detecting, through a motion sensor, a user who inputs authentication information to the operating device;
starting the printing related to the job based on the authentication information received by the operating device, with a person being detected by the motion sensor;
interrupting the job related to the printing in process when the motion sensor no longer detects a person while the started printing is in process;
receiving, before or after the interruption of the job, a selection as to whether to delete print data related to the interrupted job or to withhold the print data and use the print data when the job is resumed; and
performing a process on the interrupted job based on the selection.
